(19) United States
(12) Patent Application Publication
(10) Pub. No.: US 2009/0031899 A1
(43) Pub. Date: Feb. 5, 2009

(54) Volatile Substance Filter

(75) Inventors: Geoffrey Norman Walter Gay, Fairfield, IA (US); George Griffiths, Lancs (GB)

Correspondence Address: THE WEBB LAW FIRM, P.C., 700 KOPPERS BUILDING, 436 SEVENTH AVENUE, PITTSBURGH, PA, 15219, US

(73) Assignee: VALERION 2 LIMITED, Lancashire (GB)

(21) Appl. No.: 11/995,776

(22) PCT Filed: Jul. 13, 2006
(86) PCT No.: PCT/GB2006/002599

§ 371 Date: Aug. 13, 2008

(30) Foreign Application Priority Data
Jul. 15, 2005 (GB) 0514527.1

(51) Int. Cl. B01D 53/04

(52) U.S. Cl. 96/118; 96/154

(57) ABSTRACT

A volatile substance filter comprises volatile substance adsorber material particles on plastics material support surfaces extending parallel to the direction of gas flow through the filter.

This invention concerns volatile substance filters.

Volatile substances occur in the air (gas) of enclosed spaces and if present in sufficient concentrations can represent a danger to health of people and animals breathing the air.

In general industry, chemical plant and in exhaust systems of engines, unwanted volatile substances are also required to be removed from a gas. This may be to prevent their emission into the atmosphere for safety or to prevent them from taking part in chemical reactions at a later stage in a process. It is often, therefore, desirable to reduce the concentration of volatile substances in gases.

Various solid materials (adsorbers) are currently used to adsorb undesirable volatile substances. Among these materials is activated carbon, which is prepared in such a way as to contain a large number of internal voids whose surface area can trap volatile substances.

The adsorber solid materials represent a dense mass, which is relatively impenetrable to gas. The gas pressure drop caused by the density of the intrinsic adsorber material is too high for practical applications, as fans, blowers or other gas movers capable of blowing gases through the adsorber material would be too costly, consume impractically high levels of power and cause unacceptable levels of noise in forcing the gas at a practical velocity through the adsorber material.

Current methods of deploying adsorbers, therefore, attempt to reduce the pressure drop that occurs when gas is forced through the adsorber material. All these methods attempt to reduce the pressure drop by arranging the adsorber material so that it is distributed in space in such a way as to allow the passage of gas through or past the adsorber material particles without requiring the gas to pass directly through the solid adsorber material itself. This results in a practical volatile substance filter. It will be noted that in all these methods the gas passes substantially in a direction orthogonal to the largest surface of a support structure for the adsorber material and the arrangement of passages through this structure is essentially random and tortuous.

There are a number of methods of deploying adsorber material in current use, including reticulated or open-cell foams, adsorber granule beds, adsorber granule biscuits, perforated adsorber granule biscuits and carbon cloths.

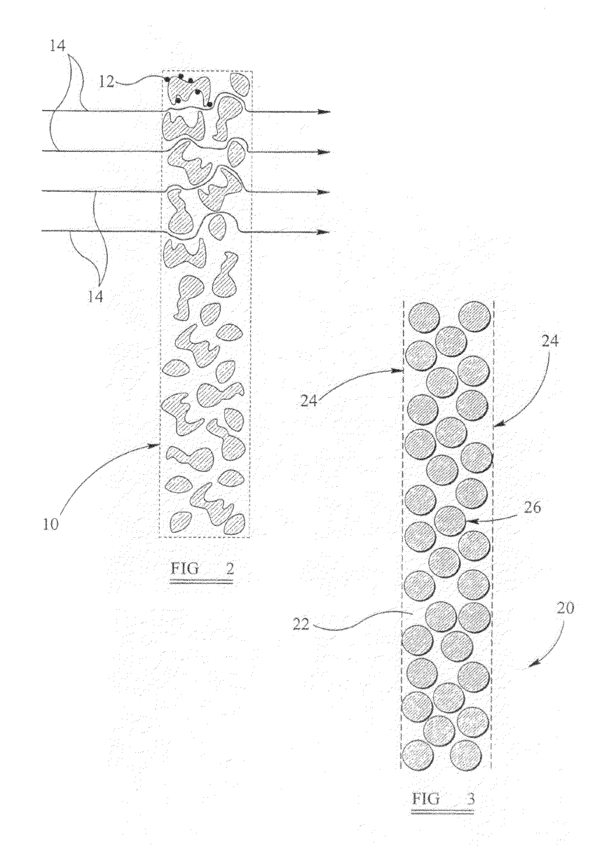

Reticulated foam is a plastics material that is formed with an open cell structure. Adsorber material particles are applied in the form of a fine powder and adhered to the inner surfaces of the foam cells. Gas can be forced through the structure, and volatile substances are thus adsorbed into the adsorber particles. FIG. 2 of the accompanying drawings shows a slab of reticulated foam 10 with gas blown through the open-cell structure. One area of foam is drawn, by way of example, with the positions of the adsorber particles 12 shown adhering to the surfaces of the open cells. Four gas flow-lines 14 are drawn by way of example, which show that the gas is forced to follow a tortuous path through the foam. This gas flow may be turbulent at practical gas velocities. Although this arrangement is of lower pressure drop than the intrinsic adsorber material, this tortuous path and the possibility of turbulent flow mean that there is a significant pressure drop resulting in the disadvantages described above. Reticulated foam of this method is designed with dimensions orthogonal to the direction of gas flow larger than the depth of the foam in the direction of gas flow. These ratios are kept large in order to minimise pressure drop. A typical filter of this method measures 15 cms by 60 cms and is 3 millimetres thick in the direction of gas flow.

Adsorber granule beds are formed by sandwiching adsorber granules between two retaining grids or meshes that allow the passage of gas blown by, for example, a fan. The mesh size of the grid is chosen so that the adsorber granules are mechanically retained between the grids, while the gas is allowed to pass through the perforations in the surface of the grid and, therefore, through the adsorber granules. The gas comes into close proximity with the adsorber granules and volatile substances are adsorbed into the adsorber granules. However, the gas flow path is tortuous and the same pressure drop problem occurs as described above. FIG. 3 of the accompanying drawings shows an adsorber granule bed formed by grids 24, which retain the adsorber granules 26. The gas flow is tortuous and potentially turbulent at practical gas velocities. As with the above-described method, the pressure drop is lower than that of the adsorber material itself but is significant with the resulting disadvantages described above.

Adsorber granule beds are designed with dimensions orthogonal to the direction of gas flow larger than the depth of the bed in the direction of gas flow. These ratios are kept large in order to minimise pressure drop.

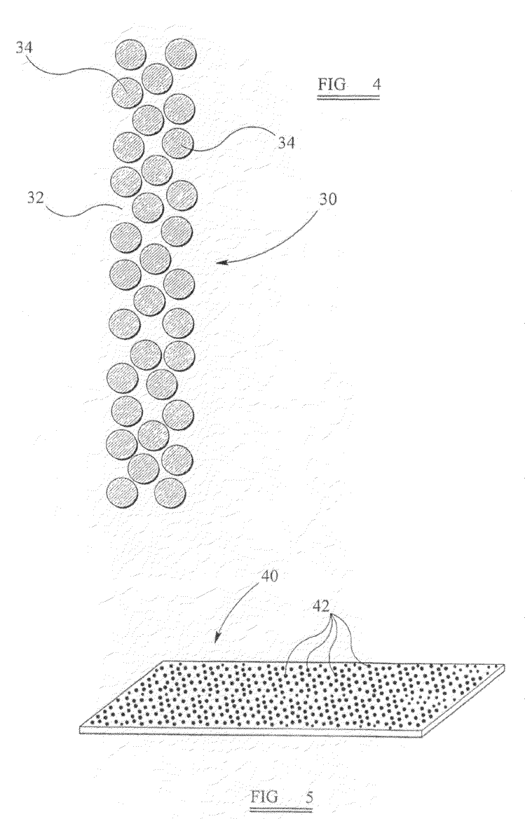

Adsorber granule biscuits are formed from adsorber granules only. The mass of granules may be adhered together by means of heat treatment and/or pressure and/or adhesive applied during manufacture. The biscuit is formed into a shape suitable for the intended application with dimensions orthogonal to the direction of gas flow larger than the depth of the biscuit in the direction of gas flow. These ratios are kept small in order to minimise pressure drop. FIG. 4 of the accompanying drawings shows granules of adsorber material 34 adhering to form the biscuit 32. It will be noted that this is a sectional view, and although the granules appear in some cases to be separate, they are in fact adhered to other granules out of the plane of the section, so that they form one connected rigid mass. The gas flow is tortuous and potentially turbulent at practical gas velocities. As with the above-described methods, the pressure drop is lower than that of the adsorber material itself but is still significant with the resulting disadvantages described above.

Perforated adsorber granule biscuits are formed in the same way as the adsorber granule biscuits described above but with the modification that voids are formed in the biscuit that do not contain adsorber granules. Typically these voids can be of 4 mm diameter and spaced at 8 mm centres and pass entirely through the biscuit in the direction of gas flow. Typically the depth of the biscuit in the direction of gas flow is around 2-12 mm. The voids allow gas to pass relatively more freely than through the adhering mass of granules, with the result that the greater proportion of the gas flow actually passes through these voids. This significantly reduces the efficiency with which the adsorber material adsorbs the volatile substances compared to forcing the gas between the adhering adsorber granules without voids. Again the biscuits are designed with dimensions orthogonal to the direction of gas flow larger than the depth of the biscuit in the direction of gas flow. These ratios are kept large in order to minimise pressure drop further.

Carbon cloth is prepared from cotton or other cloth, which is carbonised by means of a combination of chemical and heat treatment. Typically the weave of the cloth leaves voids in the array of stitching, which allow gas to pass through the cloth. The carbonisation results in imparting to the cloth the properties of an adsorber material. Volatile substances are adsorbed as the gas passes through the cloth. The cloth is woven with dimensions orthogonal to the direction of gas flow larger than the depth of the cloth in the direction of gas flow. These ratios are kept large in order to minimise pressure drop further.

The efficiency of volatile substance adsorption obtained with any of the above-described methods can be very low, typically less than the order of 10%. It can be seen, therefore, that it is difficult to produce a volatile substance adsorbing filter with low pressure drop and high adsorption efficiency.

An object of the present invention is to provide a volatile substance filter that may have improved adsorption efficiency, reduced pressure drop and longer lifetime compared to the above-described prior art filters.

According to the invention it is proposed that a volatile substance filter have volatile substance adsorber material on support surfaces extending in a direction of gas flow through the filter.

Filters according to this invention are particularly appropriate for use in the air cleaning and HVAC (Heating, Ventilation and Air Conditioning) industries where available space for a filter may be limited and where it would be advantageous to have minimal resistance to the air flow.

In preferred embodiments of this invention adsorber material particles are adhered to surfaces extending in the gas flow direction, especially parallel to the direction of gas flow. The support surfaces are, therefore, preferably oriented with respect to the gas flow direction, so as always to present a geometrically minimum possible area of the support surface in resistance to the flow of gas. This is in contradistinction to the prior art filters, wherein the gas flow is substantially orthogonal to their supporting structures and the gas velocity vectors in the proximity of adsorber material support surfaces are oriented in random directions relative to the surfaces. This difference allows pressure drops obtained in the present invention to be significantly lower than prior art filters.

The adsorber material support surfaces may be formed from a suitable plastics material for economy and lightness of weight. The support surfaces may be of thin cross section typically from 0.05 to 0.3 mm, preferably about 0.1 mm thick. This thin cross section leads to a low resistance to gas flow presented by the support surfaces keeping overall pressure drops low.

In one preferred embodiment the support surfaces are in tubular form. Such tubular support surfaces may be of cylindrical, triangular, square, hexagonal or other polygonal cross section.

In other preferred embodiments the support surfaces may be provided by an array of substantially parallel support surfaces arranged so that gas can flow across each surface. Such an arrangement may allow the support surfaces to be brought close together without an undesirable increase in pressure drop. This is because the gas can pass between the surfaces in a direct, straight, smooth and often laminar flow. This is in contradistinction to the tortuous paths and potentially turbulent flows of prior art filters, which result in unwanted pressure drops.

In filters of the invention gas containing volatile substances may, therefore, flow along and substantially parallel to the support surface and volatile substances in the gas flow immediately adjacent to the adsorber particles adhered to the support surfaces may be adsorbed. This results in a reduction in the concentration of volatile substances in the gas stream adjacent to the support surfaces and a concentration gradient orthogonal to the direction of gas flow results with a minimum concentration of volatile substances at the surface rising at greater distances from the surface. The natural result is a rapid diffusion of volatile substances along the concentration gradient towards the support surfaces. Thus, the concentration of volatile substances in a direction parallel to the support surface will also decrease rapidly with distance, as the gas flows along the surface, and high adsorption efficiencies result. Such an array of support surfaces also provides in total a large surface area on which adsorber material particles can be adhered. From these considerations it can be seen that the present invention provides a volatile substance filter, which may operate at high efficiency and low pressure drop while purifying at a practical rate useful volumes of gas.

It will be noted that in volatile substance filters according to the present invention, the gas containing volatile substances may pass substantially in a direction parallel to the largest surface of the structure, which supports the adsorber material, and the arrangement of the passages through this structure may be essentially direct and straight.

The support surfaces may be separated by separator walls, preferably plastic, also of small thickness presenting a low resistance to the gas flow.

An array of support surfaces may be formed by a simple process of extrusion in the form of a fluted plastics sheet. In another specific embodiment alternate flutes are omitted and short stubs of flute material left at each side as spacers.

Adsorber particles used in filters of the invention are preferably in a range of sizes from millimetres to 0.1 micron. It may be advantageous to use a specific size of particle or size range for different purposes. In one preferred embodiment 0.1-0.2 mm activated carbon particles are used. The particles may be adhered to the support surfaces by a method of partially melting the support surface, by using adhesive or by means of electrostatic attraction. The support structure may be filled with adsorber particles and softened in, for example, a heated oven or a microwave oven, then cooled. This attaches the particles without the need for an adhesive. If an adhesive is used it is preferably of low volatile substance emission type, such as, for example, a latex, acrylic or water based contact adhesive, silicone based adhesive or wax.

In an array of support surfaces, the surfaces are preferably separated by a distance of from 0.1 mm to 20 mm, especially from 2 to 4 mm and more especially of about 2 mm. Where the support surfaces are separated by separator walls, they are preferably spaced apart by a distance of from 0.5 mm to 20 mm, especially from 2 to 6 mm and more especially about 2 mm.

The volatile substance adsorber material used in the invention may be any suitable material, of which activated carbon particles or granules is a preferred example. Other materials, such as zeolites, silica gel, calcium chloride, or any similar hygroscopic or deliquescent material or special materials for removal of specific gases may also be used as the adsorber material in the present invention.

Preferred filters according to the invention will also include means for urging gas flow therethrough, such as a fan.

This invention will now be further described, by way of example only, with reference to the accompanying drawings, in which:

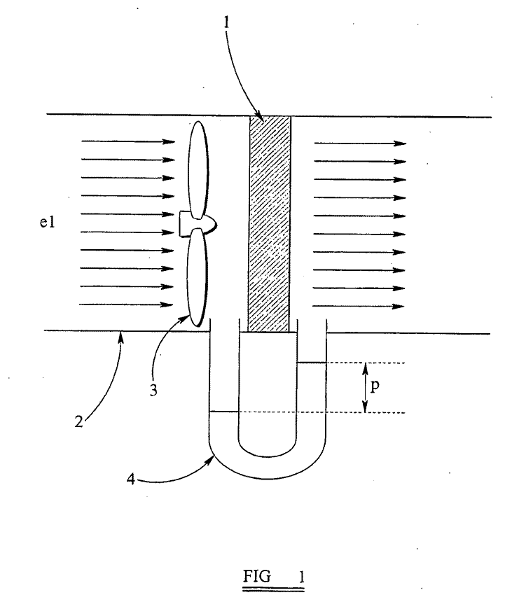

FIG. 1 shows a prior art volatile substance filter in a gas duct with a fan forcing gas through a solid piece of adsorber material;

FIG. 2 shows a slab of reticulated foam with adsorber particles adhered onto inner surfaces of open cells;

FIG. 3 shows an adsorber granule bed;

FIG. 4 shows an adsorber granule biscuit;

FIG. 5 shows a support surface for a volatile substance filter according to the invention with adhered adsorber particles;

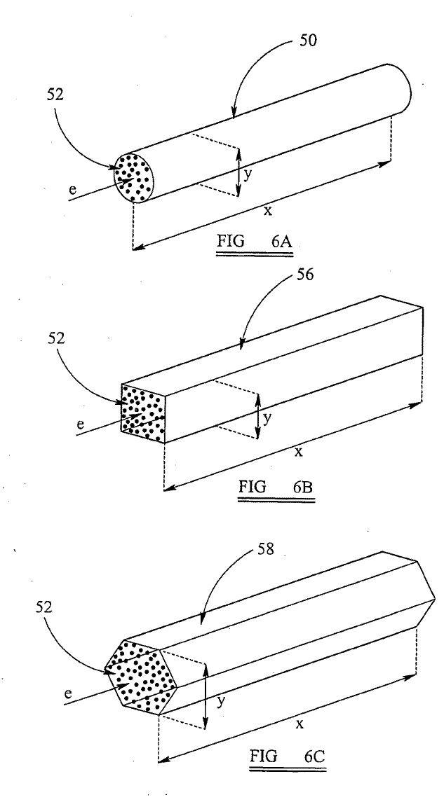

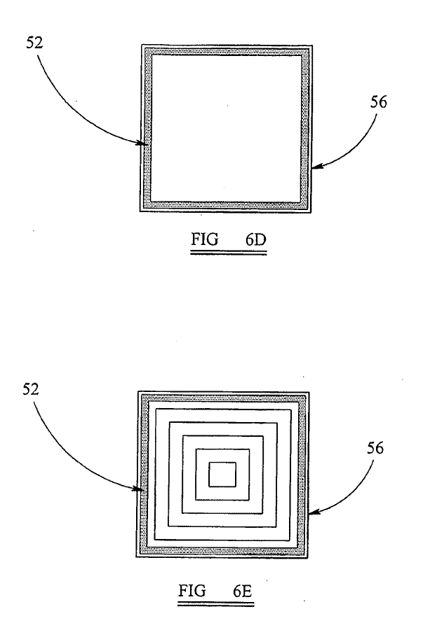

FIG. 6A shows a support surface of cylindrical cross section;

FIG. 6B shows a support surface of square cross section;

FIG. 6C shows a support surface of hexagonal cross section;

FIG. 6D shows a cross section through the support surface of FIG. 6D.

FIG. 6E shows the volatile substance equal density lines within the same cross section as FIG. 6D.

FIG. 7 shows a parallel array of support surfaces;

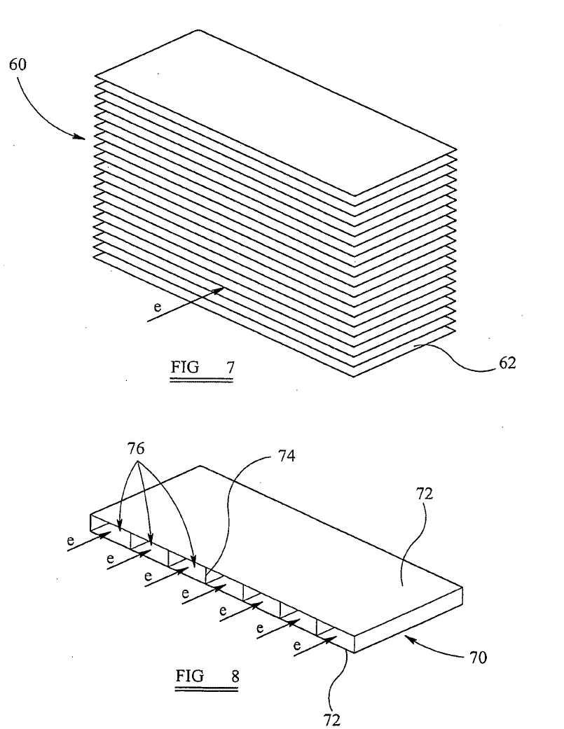

FIG. 8 shows a fluted sheet providing an array of support surfaces;

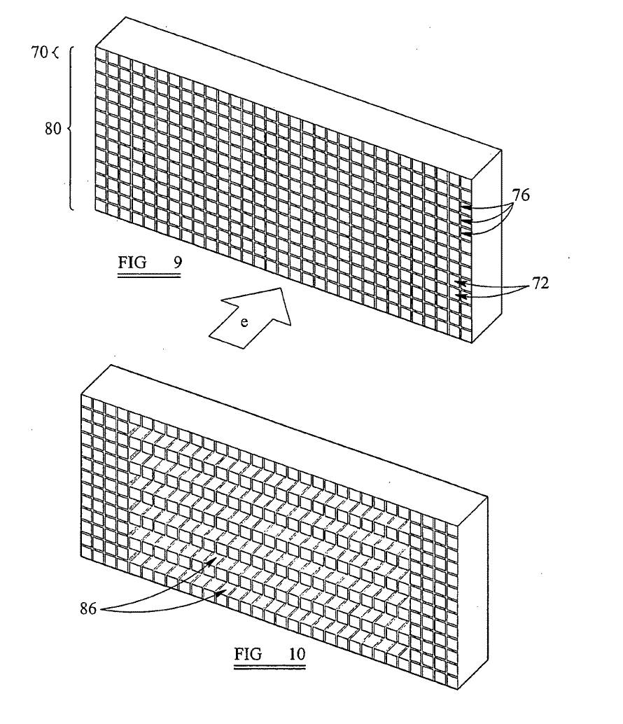

FIG. 9 shows a practical form of a volatile substance filter formed from a stack of fluted sheets; and

FIG. 10 shows a modification of the filter of FIG. 9.

Referring to FIG. 1 of the accompanying drawings, there is shown a volatile substance filter 1 situated in a gas duct 2 with a fan 3 forcing gas through the filter. The filter 1 is in the form of a piece of adsorber material. A manometer 4 shows the pressure drop (p) across the adsorber filter. The gas flow (e1) approaching the adsorber material filter has a high volatile substance concentration. After passage through the adsorber material filter the gas flow (e2) contains a lower volatile substance concentration. For some practical applications, the pressure drop (p) is too high.

FIG. 2 of the accompanying drawings shows a volatile substance filter in the form of a slab of reticulated foam 10 containing open cells, on the bounding solid surfaces of which are adhered volatile substance adsorber particles 12. The tortuous path of the gas flow through the foam is shown by the flow-lines 14 and results in undesirable pressure drop. The necessity to keep the ratio of the depth of the volatile substance filter in the direction of gas flow to the dimensions of the surface orthogonal to the gas flow large reduces the dwell time of the gas flow through the filter, thereby reducing the efficiency of volatile substance adsorption.

FIG. 3 shows a volatile substance filter 20 in the form of an adsorber granule bed 22 with retaining grids or meshes 24 retaining adsorber material granules 26. Gas flow through the filter 20 is similarly tortuous and produces undesirable pressure drop as with the reticulated foam shown in FIG. 2. The necessity to keep the ratio of the depth of the volatile substance filter in the direction of gas flow to the dimensions of the surface orthogonal to the gas flow large reduces the dwell time of the gas flow through the filter, thereby reducing the efficiency of volatile substance adsorption.

FIG. 4 shows a volatile substance filter 30 in the form of an adsorber material granule biscuit 32 composed of adhering adsorber particles 34. Gas flow is similarly tortuous and produces undesirable pressure drop as with the reticulated foam and adsorber granule beds described above in relation to FIGS. 2 and 3. The necessity to keep the ratio of the depth of the volatile substance filter in the direction of gas flow to the dimensions of the surface orthogonal to the gas flow large reduces the dwell time of the gas flow through the filter, thereby reducing the efficiency of volatile substance adsorption.

Turning to FIG. 5 of the accompanying drawings there is shown a support 40 for a volatile substance filter according to the invention. Upon both upper and lower surfaces of the support are adhered adsorber material particles 42. In a filter using the supports 40, gas to be purified of volatile substances is caused to flow along the support surfaces.

FIG. 6A shows a support surface 50 for a volatile substance filter of the invention in the form of a circular cross section tube of plastics material, upon the inner surfaces of which are adhered adsorber material particles 52. Gas to be purified of volatile substances is caused to flow through the tube 50 and hence along the inner surface thereof in the direction of the arrow e. Such a support can form an element of a practical filter composed of a spaced and connected array of such supports.

Alternatively, as shown in FIGS. 6B and 6C, instead of circular sections tubes a filter of the invention may be constructed from square section or hexagonal tubes 56 and 58 respectively.

FIG. 6D shows a cross section through the support surface of FIG. 6B, in a plane orthogonal to the airflow direction (at right angles to the longitudinal axis). The adsorber material 52 is shown covering the inner surfaces of the tube 56.

FIG. 6E shows the volatile substance density equal-density lines drawn within the same cross section as FIG. 6D. It can be seen, that due to the adsorption of volatile substances onto the adsorber material there is a density gradient set up, with a maximum on the axis of the support surface and a minimum adjacent to the surface itself, which causes rapid diffusion of volatile substance molecules towards the support surface inner surfaces.

It will be noted that the basic elements (shown in FIGS. 6A, 6B and 6E) of practical filters constructed according to this invention have a depth in the direction of airflow (x) larger than the dimensions of the section orthogonal to the airflow (y). Furthermore, the depth of arrays of these elements forming a practical volatile substance filter of this invention can be substantially larger than the depths of volatile substance filters of prior art for similar gas pressure drop and dimensions of the section or face presented orthogonally to the gas flow. This leads to significantly higher volatile substance adsorption efficiencies. inner surfaces of which are adhered adsorber material particles 52. Gas to be purified of volatile substances is caused to flow through the tube 50 and hence along the inner surface thereof in the direction of the arrow e. Such a support can form an element of a practical filter composed of a spaced and connected array of such supports.

Alternatively, as shown in FIGS. 6B and 6C, instead of circular sections tubes a filter of the invention may be constructed from square section or hexagonal tubes 56 and 58 respectively.

FIG. 6D shows a cross section through the support surface of FIG. 6B, in a plane orthogonal to the airflow direction (at right angles to the longitudinal axis). The adsorber material 52 is shown covering the inner surfaces of the tube 56.

FIG. 6E shows the volatile substance density equal-density lines drawn within the same cross section as FIG. 6D. It can be seen, that due to the adsorption of volatile substances onto the adsorber material there is a density gradient set up, with a maximum on the axis of the support surface and a minimum adjacent to the surface itself, which causes rapid diffusion of volatile substance molecules towards the support surface inner surfaces.

It will be noted that the basic elements (shown in FIGS. 6A, 6B and 6E) of practical filters constructed according to this invention have a depth in the direction of airflow (x) larger than the dimensions of the section orthogonal to the airflow (y). Furthermore, the depth of arrays of these elements forming a practical volatile substance filter of this invention can be substantially larger than the depths of volatile substance filters of prior art for similar gas pressure drop and dimensions of the section or face presented orthogonally to the gas flow. This leads to significantly higher volatile substance adsorption efficiencies.

A filter was made according to the embodiment of a circular cross-section tube (as in FIG. 6A). It was made with 6 mm diameter polypropylene straws with 0.15 mm thick walls. The same heating process was used as before to fuse the carbon particles to the tubes except the particles were of size range 0.2-0.6 mm. This process also closed the gap between tubes and fused them together, increasing the strength and giving structural integrity to the filter. In this case 59% of the final weight of the filter was active carbon material. An efficiency of 19% was obtained at 2 m/s using a test volatile substance of 50 ppm 2,2,4 trimethylpentane and the filter bad a pressure drop of only 22 Pa. In another embodiment slight adjustments to the baking process made the tubes deform into a hexagonal honeycomb like structure (FIG. 6C).

FIG. 7 shows an array 60 of support surfaces 62 of plastics material, which are covered on both sides with adhered adsorber particles for incorporation in a filter for removing volatile substances from a gas stream flowing between the support surfaces in the direction shown by the arrow (e). The low pressure drop resulting from the parallel, smooth, direct and non-turbulent gas flow provided by this arrangement allows the ratio of the depth of the volatile substance filter in the direction of gas flow to the dimensions of the surface orthogonal to the gas flow to be significantly smaller than in prior art filters described above. This means that the dwell time within the filter of volatile substances in the gas flow is long enough to allow the volatile substances to be adsorbed by the adsorber material particles at high efficiency.

In FIG. 8 there is shown a single fluted sheet of plastics material 70 providing support surfaces 72 on the inner surfaces of its upper and lower sides separated by separator walls 74. Adsorber material particles are adhered to these two surfaces to provide an element for a practical volatile substance filter of the invention. Additionally, adsorber material particles may be adhered to both surfaces of each separator wall 74. Gas flow (e) into each and every flute opening 76 results in efficient adsorption of any volatile substances contained within the gas flow at low pressure drop.

FIG. 9 shows a stack 80 of the fluted sheets 70 described in relation to FIG. 8 of the drawings, wherein the support surfaces 72 have adsorber material particles adhered thereto. This stack forms the basis of a volatile substance filter according to the invention. Gas flow into each and every flute opening 76 of each and every fluted sheet 70 in the stack 80 results in efficient adsorption of any volatile substances contained within the gas flow at low pressure drop for the treatment of practical volumes of gas. The low pressure drop resulting from the parallel, smooth, direct and non-turbulent gas flow provided by this arrangement allows the ratio of the depth of the volatile substance filter in the direction of gas flow to the dimensions of the surface orthogonal to the gas flow to be significantly smaller than the methods described above. This means that dwell time within the filter of volatile substances in the gas flow is long enough to allow the volatile substances to be adsorbed by the adsorber material particles at high efficiency.

One specific filter embodiment (FIG. 9) was made from ‘2 mm’ polypropylene extruded plastic sheet (FIG. 8) where 2 mm is the external measurement between upper and lower walls (72), the walls themselves were 0.15 mm thick. These were cut into strips 40 mm wide and assembled into a stack to form the array. This stack was laid sideways on a baking tray, filled with coconut shell based active carbon in the size range 0.1-0.2 mm and baked in an oven for one hour. The temperature of the oven was chosen to be close to the melting point of the plastic. For polypropylene 180C was chosen but polyethylene or other plastics could be used with a different appropriate temperature. The filter was then removed, allowed to cool and excess carbon was drained from the flutes. 40% of the final weight of the filter was carbon material, representing a high loading factor compared compared to the weight of the support structure. Efficiencies of 28% were obtained at 2 m/s using a test volatile substance of 50 ppm 2,2,4 trimethylpentane and the filter had a pressure drop of 24 Pa. Other embodiments have used 1.5 mm, 4 mm, 6 mm and 10 mm fluted material with either coconut shell or coal based activated carbon.

Other embodiments have used glues instead of this heat-fusing process, using a latex, acrylic or water based contact adhesive, silicone based adhesive or wax.

FIG. 10 shows a filter of the same type as Filter 9 but where alternate flutes are omitted by having short stubs of flute material left at each side as spacers. This gives a wide void each alternate flute, which helps to reduce the pressure drop. Much larger voids 86 are created in this filter, the insides of which are also coated with adsorber material. The large size of these voids is a preferential path for air and allows small or substantially filled flutes to be used without seriously increasing the pressure drop.

Filters according to the invention should be simple to manufacture, be of low cost and have structural stability. Prior art filters can provide high efficiencies but with the penalties of too high a pressure drop or too deep a filter. To make an improvement in efficiency, pressure drop and filter lifetime an understanding is needed of the variables that may affect them. The variables acting on the filter are as follows:

### For Efficiency:

Filter Aperture size (76 on FIG. 9, typically 2 mm)
Filter depth (72 on FIG. 9, typically 20-75 mm)
Filter aperture wall thickness (typically 0.1-0.5 mm)
Air Velocity, usually referred to as the ‘Face Velocity’ the velocity of air going through the filter as measured on the leading or trailing face (typically 2 m/s)
Adsorber particle size (typically 0.1-0.2 mm)
Adsorber particle type (typically activated carbon)
Adsorber particle mass in filter (typically 10 g for a 52×67×20 mm filter)
Adsorber particle adhesion method (typically by fusing to plastic, PVA glue)
Volatile challenge substance used (typically 2,2,4 trimethylpentane)
Concentration of volatile challenge used during testing (typically 50 ppm)
Duration tested (typically no more than 2 mins at these concentrations)

### For Pressure Drop

Filter Aperture size (typically 2 mm)
Filter depth (typically 20-75 nmm)
Filter aperture wall thickness (typically 0.1-0.5 mm)
Air Velocity, usually referred to as the ‘Face Velocity’ the velocity of air going through the filter as measured on the leading or trailing face (typically 2 m/s)
Adsorber particle size (typically 0.1-0.2 mm)
Adsorber particle mass in filter (typically 10 g for a 52×67×20 mm filter)

### For Lifetime

Adsorber particle size (typically 0.1-0.2 mm)
Adsorber particle mass in filter (typically 10 g for a 52×67×20 nm filter) volatile substance loading
Volatile substance filters of the invention may have a variety of applications and may be included in domestic air cleaners and air conditioning systems.

1. A volatile substance filter comprising volatile substance adsorber material on support surfaces extending in a direction of gas flow through the filter.

2. A filter as claimed in claim 1, wherein the support surfaces are parallel to the direction of gas flow.

3. A filter as claimed in claim, wherein the adsorber material support surfaces are formed from plastics material.

4. A filter as claimed in claim 3, wherein the support surfaces are of thin cross section.

5. A filter as claimed in claim 4, wherein the support surfaces are 0.05 to 0.3 mm thick.

6. A filter as claimed in claim 4, wherein the support surfaces are 0.1 mm thick.

7. A filter as claimed in any one of claims 1 to 6, wherein the support surfaces are in tubular form.

8. A filter as claimed in claim 7, wherein the tubular support surfaces are of cylindrical, square or other polygonal cross section.

9. A filter as claimed in any one of claims 1 to 6, wherein the support surfaces are provided by an array of substantially parallel support surfaces arranged so that gas can flow across each surface.

10. A filter as claimed in claim 9, wherein the support surfaces are separated by separator walls.

11. A filter as claimed in claim 10, wherein the separator walls are of plastics material.

12. A filter as claimed in claim 10 or 11, wherein the separator walls are of small thickness.

13. A filter as claimed in claim 10, 11 or 12 comprising an array of extruded fluted plastics sheet material.

14. A filter as claimed in claim 13, wherein alternate flutes are omitted and stubs of flute material left at sides as spacers.

15. A filter as claimed in any one of claims 1 to 14, wherein the adsorber material particles are in a range of sizes from millimetres to 0.1 micron.

16. A filter as claimed in any one of claims 1 to 15, wherein the adsorber material is activated carbon particles of 0.1 to 0.2 mm size.

17. A filter as claimed in any one of claims 1 to 16, wherein the adsorber material particles are adhered to the support surfaces by partially melting the support surfaces.

18. A filter as claimed in claim 17, wherein the support surfaces are partially melted in a heated oven or a microwave oven.

19. A filter as claimed in any one of claims 1 to 16, wherein the adsorber material particles are adhered to the support surfaces by electrostatic attraction.

20. A filter as claimed in any one of claims 1 to 16, wherein the adsorber material particles are adhered to the support surfaces by adhesive.

21. A filter as claimed in claim 20, wherein the adhesive is of low volatile substance emissions type.

22. A filter as claimed in claim 21, wherein the adhesive is selected from latex, acrylic or water based contact adhesives, silicone based adhesives and wax.

23. A filter as claimed in claim 19, wherein the adsorber material particles are charged electrically prior to adhesion.

24. A filter as claimed in claim 23, wherein the support surfaces are oppositely charged electrically to facilitate adhesion.

25. A filter as claimed in any one of claims 9 to 24, wherein the support surfaces are separated by a distance of from 0.1 mm to 20 mm.

26. A filter as claimed in claim 25, wherein the support surfaces are separated by a distance of from 2 to 4 mm.

27. A filter as claimed in claim 25, wherein the support surfaces are separated by a distance of about 2 mm.

28. A filter as claimed in any one of claims 10 to 27, wherein, when the support surfaces are separated by separator walls, the separator walls are spaced apart by a distance of from 0.5 mm to 20 mm.

29. A filter as claimed in claim 28, wherein the separator walls are spaced apart by a distance of from 2 to 6 mm.

30. A filter as claimed in claim 28, wherein the separator walls are spaced apart by a distance of about 2 mm.

31. A filter as claimed in any one of claims 1 to 30, wherein the volatile substance adsorber material is activated carbon particles or granules.

32. A filter as claimed in any one of claims 1 to 30, wherein the adsorber material is a hygroscopic or deliquescent material.

33. A filter as claimed in any one of claims 1 to 30, wherein the adsorber material is selected from zeolites, silica gel and calcium chloride.

34. A filter as claimed in any one of claims 1 to 33 including means for urging gas flow therethrough

35. A filter as claimed in claim 34, wherein the urging means is a fan.

36. A volatile substance filter substantially as hereinbefore described with reference to and as illustrated in any one of FIGS. 5 to 10 of the accompanying drawings.
